(19) United States
(12) Patent Application Publication
(10) Pub. No.: US 2012/0078635 A1
(43) Pub. Date: Mar. 29, 2012

(54) VOICE CONTROL SYSTEM

(75) Inventors: Fletcher Rothkopf, Los Altos, CA (US); Stephen Brian Lynch, Portola Valley, CA (US); Adam Mittleman, San Francisco, CA (US); Phil Hobson, Menlo Park, CA (US)

(73) Assignee: Apple Inc., Cupertino, CA (US)

(21) Appl. No.: 12/890,091

(22) Filed: Sep. 24, 2010

(51) Int. Cl. G10L 15/28

(52) U.S. Cl. 704/270.1; 704/E15.007

(57) ABSTRACT

One embodiment of a voice control system includes a first electronic device communicatively coupled to a server and configured to receive a speech recognition file from the server. The speech recognition file may include a speech recognition algorithm for converting one or more voice commands into text and a database including one or more entries comprising one or more voice commands and one or more executable commands associated with the one or more voice commands.

### BACKGROUND

I. Technical Field

Embodiments described herein relate generally to devices for controlling electronic devices and, in particular, to a voice control system for training an electronic device to recognize voice commands.

II. Background Discussion

Portable electronic devices, such as digital media players, personal digital assistants, mobile phones, and so on, typically rely on small buttons and screens for user input. Such controls may be built into the device or part of a touch-screen interface, but are typically very small and can be cumbersome to manipulate. An accurate and reliable voice user interface that can execute the functions associated with the controls of a device may greatly enhance the functionality of portable devices.

However, speech recognition algorithms typically require extensive computational hardware and/or software that may not be practical on a small product. For example, adding the requisite amount of computational power and storage to enable voice recognition on a small device may increase the associated manufacturing costs, as well as add to the bulk and weight of the finished product. What is needed is an electronic device that includes a voice user interface for executing voice or oral commands from a user, but where voice recognition is performed by a remote device communicatively coupled to the electronic device, rather than the electronic device itself.

### SUMMARY

Embodiments described herein relate to voice control systems. One embodiment may include a first electronic device communicatively coupled to a server and to a second electronic device. The second electronic device may be a portable electronic device, such as a digital media player, that includes a voice user interface. In one embodiment, the first electronic device may be a wireless communication device, such as a cellular or mobile phone. In another embodiment, the first electronic device may be a laptop or desktop computer capable of connecting to the server. Voice commands received by the second electronic device may be recorded and transmitted as a recorded voice command file to the first electronic device. The first electronic device may then transmit the recorded voice command file to the server, which may run a speech recognition engine that is configured to perform voice recognition on the recorded voice command file to derive a speech recognition algorithm. The server may transmit the algorithm to the first and second electronic devices, thereby enabling them to use the algorithm to independently perform speech recognition.

One embodiment may take the form of a voice control system that includes a first electronic device communicatively coupled to a server and configured to receive a speech recognition file from the server. The speech recognition file may include a speech recognition algorithm for converting one or more voice commands into text and a database including one or more entries including one or more voice commands and one or more executable commands associated with the one or more voice commands.

Another embodiment may take the form of a method for creating a database of voice commands on a first electronic device. The method may include transmitting a voice recording file to a server and receiving a first speech recognition file from the server. The first speech recognition file may include a first speech recognition algorithm and a first database including one or more entries comprising one or more voice commands and one or more executable commands corresponding to the one or more voice commands. The method may further include creating a second database including one or more entries from at least one of the one or more entries of the first database of the speech recognition file.

Another embodiment may take a form of a voice control system that includes a server configured to receive a voice command recording. The server may be configured to process the voice command recording to obtain a speech recognition file including a speech recognition algorithm and a database including one or more voice commands and one or more executable commands corresponding to the one or more voice commands. The server may be further configured to transmit the speech recognition algorithm to a first electronic device communicatively coupled to the server.

### BRIEF DESCRIPTION OF THE DRAWINGS

FIG. 1 illustrates one embodiment of a voice control system.

FIG. 2 illustrates one embodiment of a first electronic device that may be used in conjunction with the embodiment illustrated in FIG. 1.

FIG. 3 illustrates one embodiment of a server that may be used in conjunction with the embodiment illustrated in FIG. 1.

FIG. 4 illustrates one embodiment of a second electronic device that may be used in conjunction with the embodiment illustrated in FIG. 1.

FIG. 5 illustrates a flowchart setting forth one embodiment of a method for associating a voice command with an executable command.

FIG. 6 illustrates a flowchart setting forth one embodiment of a method for creating a database of voice commands.

FIG. 7 illustrates a flowchart setting forth one embodiment of a method for performing voice recognition.

### DETAILED DESCRIPTION

Embodiments described herein relate to voice control systems. One embodiment may include a first electronic device communicatively coupled to a server and to a second electronic device. The second electronic device may be a portable electronic device, such as a digital media player, that includes a voice user interface. In one embodiment, the first electronic device may be a wireless communication device, such as a cellular or mobile phone. In another embodiment, the first electronic device may be a laptop or desktop computer capable of connecting to the server. Voice commands received by the second electronic device may be recorded and transmitted as a recorded voice command file to the first electronic device. The first electronic device may then transmit the recorded voice command file to the server, which may run a speech recognition engine that is configured to perform voice recognition on the recorded voice command file to derive a speech recognition algorithm. The server may transmit the algorithm to the first and second electronic devices, thereby enabling them to use the algorithm to independently perform speech recognition.

Speech recognition engines typically use acoustic and language models to recognize speech. An acoustic model may be created by taking audio recordings of speech and their transcriptions, and combining them to obtain a statistical representation of the sounds that make up each word. A language or grammar model may contain probabilities of sequences of words, or alternatively, sets of predefined combinations of words, that may be used to predict the next word in a speech sequence. The accuracy of the acoustic and language models may be improved, and the speech recognition engine “trained” to better recognize speech, as more speech recordings are supplied to the speech recognition engine.

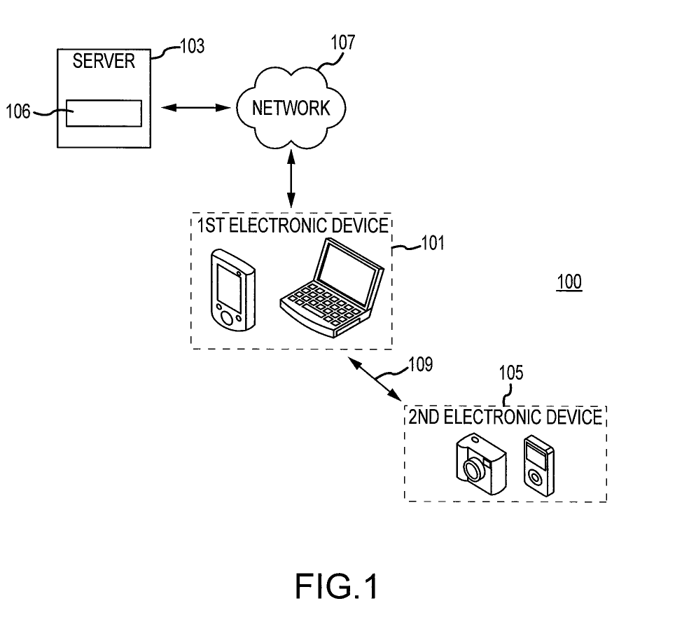

FIG. 1 illustrates one embodiment of a voice control system 100. As shown in FIG. 1, the voice control system may include a first electronic device 101 that is communicatively coupled to a server 103 and a second electronic device 105 that is communicatively coupled to the first electronic device. In one embodiment, the first electronic device 101 may be communicatively coupled to the server 103 via a wireless network 107. For example, the first electronic device 101 and the server 103 may be communicatively coupled via a personal area network, a local area network, a wide area network, a mobile device network (such as a Global System for Mobile Communication network, a Cellular Digital Packet Data network, Code Division Multiple Access network, and so on), and so on and so forth. In other embodiments, the first electronic device 101 and the server 103 may be connected via a wired connection.

In one embodiment, the second electronic device 105 may be communicatively coupled to the first electronic device 101 via a wired connection 109. For example, the second electronic device 105 may be connected to the first electronic device 101 by a wire or other electrical conductor. In other embodiments, the second electronic device 105 may be wirelessly connected to the first electronic device. For example, the second electronic device 105 may be configured to transmit the signals to the first electronic device 101 using any wireless transmission medium, such as an infrared, radio frequency, microwave, or other electromagnetic medium.

As will be further discussed below, the second electronic device 105 may be configured to receive and record an oral or voice command from a user. The voice command may correspond to one or more executable commands or macros that may be executed on the second electronic device. As will be further discussed below, the second electronic device 105 may also be configured perform voice recognition on received voice commands. More particularly, the second electronic device 105 may utilize a speech recognition algorithm developed and supplied by the server 103.

The second electronic device 105 may be further configured to transmit the recorded voice command to the first electronic device 101, which, as discussed above, may be communicatively coupled to the server 103. The first electronic device 101 may transmit the recorded voice command file to the server 103, and the server 103 may perform voice recognition on the recorded voice command file. In one embodiment, the server 103 may run a trainable speech recognition engine 106. The speech recognition engine 106 may be software configured to generate a speech recognition algorithm based on one or more recorded voice command files that are supplied from the first or second electronic devices 101, 105. In one embodiment, the algorithm may be a neural network or a decision tree that converts spoken words into text. The algorithm may be based on various features of the user's speech, such as the duration of various frequencies of the user's voice and/or patterns in variances in frequency as the user speaks.

The speech recognition engine 106 may produce different types of algorithms. For example, in one embodiment, the algorithm may be configured to recognize one particular speaker by distinguishing the speaker from other speakers. In another embodiment, the algorithm may be configured to recognize words, regardless of which speaker is speaking the words. In a further embodiment, the algorithm may be first configured to distinguish the speaker from other speakers and then to recognize words spoken by the speaker. As alluded to above, the accuracy of the algorithm may be improved as the engine processes more recorded voice command files. Accordingly, the server 103 may be “trained” to better recognize the voice of the user (i.e., to distinguish the user from other speakers) or to more accurately identify spoken commands.

The speech recognition engine 106 may produce a speech recognition file that includes an algorithm, as well as a database containing one or more voice commands (e.g., in text format) and associated executable commands. The database may be a relational database, such as a look-up table, an array, an associative array, and so on and so forth. In one embodiment, the server 103 may transmit the speech recognition file to the first electronic device. In one embodiment, the first electronic device 101 may download selected voice commands from the database of the speech recognition file. However, in other embodiments, the first electronic device 101 may download the entire database of voice commands in the speech recognition file. In some embodiments, the first electronic device 101 may receive multiple speech recognition files from the server 103 and selectively add commands to its local database.

The relationships between the voice commands and the executable commands may be defined in different ways. For example, in one embodiment, the relationship may be predefined within the server 103 by the manufacturer of the second electronic device 105 or some other party. In another embodiment, the user may manually associate buttons provided on the second electronic device 105 with particular voice commands. For example, the user may press a “play” button on the second electronic device, and simultaneously speak and record the word “play.” The second electronic device 105 may then generate a file that contains the recorded voice command file and the corresponding commands that are executed when the “play” button is pressed. This file may then be transmitted to the server 103, which may perform voice recognition on the voice recording.

In one embodiment, the first electronic device 101 may be configured to transmit the speech recognition file to the second electronic device 105. In other embodiments, the second electronic device 105 may be configured to download selected voice commands from the speech recognition file. The second electronic device 105 may use the algorithm contained in the speech recognition file to recognize one or more voice commands. Accordingly, the second electronic device 105 may be capable of accurate speech recognition, but may not include additional computational hardware and/or software for training the speech recognition engine. Instead, the computational hardware and/or software required for such training may be provided on an external server 103. As such, the bulk, weight, and cost for manufacturing the second electronic device 105 may be reduced, resulting in a more portable and affordable product.

In another embodiment, the first electronic device 101 may also be configured to receive and record live voice commands corresponding to the second electronic device. The recorded voice commands may be transmitted to the server 103 for voice recognition processing and creation of a speech recognition file. The speech recognition file may then be transmitted to the first electronic device, which may save the algorithm and create a local database containing selected voice commands and corresponding executable commands. The algorithm, as well as the commands from the local database of the first electronic device 101, may then be transmitted to the second electronic device.

In a further embodiment, the first electronic device 101 may be configured to receive and record live voice commands corresponding to its own controls. The recorded voice commands may be transmitted to the server 103 for voice recognition processing and creation of a speech recognition file, which may be transmitted to the first electronic device. The first electronic device 101 may then use the algorithm contained in the speech recognition file to establish a voice user interface on the first electronic device 101.

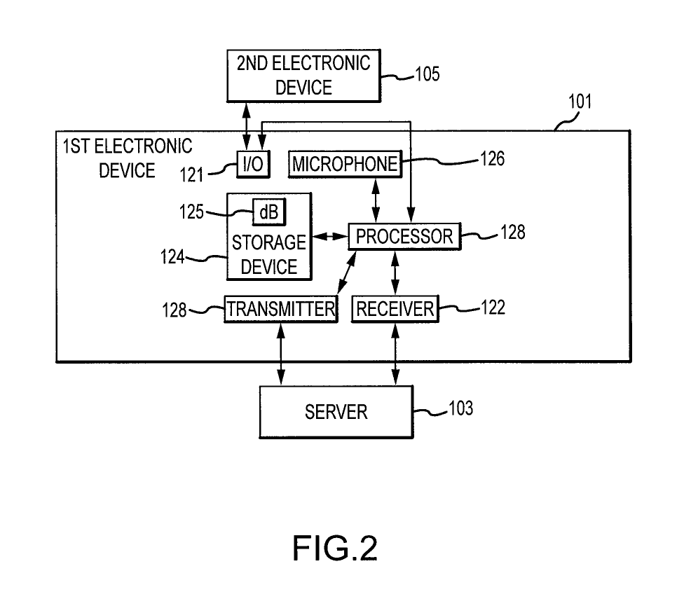

FIG. 2 illustrates one embodiment of a first electronic device 101 that may be used in conjunction with the embodiment illustrated in FIG. 1. As shown in FIG. 2, the first electronic device 101 may include a transmitter 120, a receiver 122, a storage device 124, a microphone 126, and a processing device 128. The first electronic device 101 may also include optional input and output ports (or a single input/output port 121) for establishing a wired connection with the second electronic device 105. In other embodiments, the first and second electronic devices 101, 105 may be wirelessly connected.

In one embodiment, the first electronic device 101 may be a wireless communication device. The wireless communication device may include various fixed, mobile, and/or portable devices. Such devices may include, but are not limited to, cellular or mobile telephones, two-way radios, personal digital assistants, digital music players, Global Position System units, wireless keyboards, computer mice, and/or headsets, set-top boxes, and so on and so forth. In other embodiments, the first electronic device 101 may take the form of some other type of electronic device capable of wireless communication. For example, the first electronic device 101 may be a laptop computer or a desktop computer capable of connecting to the Internet.

The microphone 126 may be configured to receive one or more voice commands from the user and convert the voice commands into an electric signal. The electric signal may then be stored as a recorded voice command file on the storage device 124. The recorded voice command file may be in a format that is supported by the device, such as a .wav, .mp3, .vnf, or other type of audio or video file. In another embodiment, the first electronic device 101 may be configured to receive a recorded voice command file from another electronic device. For example, the first electronic device 101 may be configured to receive a recorded voice command file from the second electronic device, from the server 103, or from some other electronic device communicatively coupled to the first electronic device. In such embodiments, the first electronic device 101 may or may not include a microphone for receiving voice commands from the user. Instead, the recorded voice command file may be received from another electronic device configured to record the voice commands. Some embodiments may be configured both to receive a recorded voice command file from another electronic device and record voice commands spoken by a user.

As discussed above, the first electronic device 101 may also include a transmitter 120 configured to transmit the recorded voice command file to the server 103, and a receiver 122 configured to receive speech recognition files from the server 103. In one embodiment, the received speech recognition files may be transmitted by the receiver 122 to the storage device 124, which may save the algorithm and compile the received voice commands and their corresponding executable commands into a local database 125. As alluded to above, the local database 125 may be a look-up table matching each voice command to a corresponding command or macro that can be executed by the second electronic device.

In one embodiment, the first electronic device 101 may allow a user to populate the local database 125 with selected voice commands. Accordingly, a user may determine whether all or only some of the commands in a particular speech recognition file may be downloaded into the database 125. This feature may be useful, for example, when the storage device 124 only has a limited amount of free storage space available. Additionally, a user may be able to populate the database 125 with commands from multiple speech recognition files. For example, the resulting database 125 may include different commands from three or four different speech recognition files. In a further embodiment, a user may also update entries within the database 125 as they are received from the server 103. For example, the first electronic device 101 may update the voice commands with different commands. Similarly, the first electronic device 101 may change the executable commands associated with the voice commands. In other embodiments, the algorithm may also be replaced with more accurate algorithms as they become available from the server.

The storage device 124 may store software or firmware for running the first electronic device 101. For example, in one embodiment, the storage device 124 may store system software that includes a set of instructions that are executable on the processing device 128 to enable the setup, operation and control of the first electronic device 101. The processing device 128 may also perform other functions, such as allocating memory within the storage device 124, as necessary, to create the local database 125. The processing device 128 can be any of various commercially available processors, including, but not limited to, a microprocessor, central processing unit, and so on, and can include multiple processors and/or co-processors.

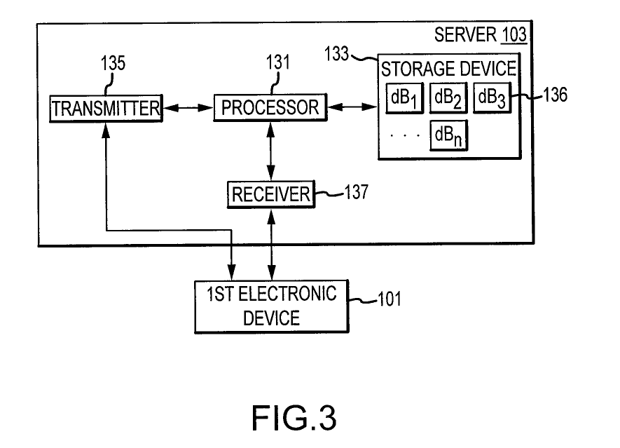

FIG. 3 illustrates one embodiment of a server 103 that may be used in conjunction with the embodiment illustrated in FIG. 1. The server 103 may be a personal computer or a dedicated server 103. As shown in FIG. 3, the server 103 may include a processing device 131, a storage device 133, a transmitter 135, and a receiver 137. As discussed above, the receiver 137 may be configured to receive the recorded voice command file from the first electronic device, and the transmitter 135 may be configured to transmit one or more speech recognition files to the first electronic device 101.

The storage device 133 may store software or firmware for performing the functions of the speech recognition engine. For example, the storage device 133 may store a set of instructions that are executable on the processing device 131 to perform speech recognition on the received recorded voice command file and to produce a speech recognition algorithm based on the received voice recordings. The processing device 131 can be any of various commercially available processors, but should have sufficient processing capacity both to perform voice recognition on the recorded voice commands and to produce the speech recognition algorithm. The processing device 131 may take the form of, but is not limited to, a microprocessor, central processing unit, and so on, and can include multiple processors and/or co-processors.

In one embodiment, the server may run commercially available speech recognition software to perform the speech recognition and algorithm generation functions. One example of a suitable speech recognition software product is Dragon NaturallySpeaking, available from Nuance, Inc. Other embodiments may utilize a custom speech recognition process and may apply various combinations of acoustic and language modeling techniques for converting spoken words to text.

As discussed above, the user may “train” the speech recognition engine to improve its accuracy. In one embodiment, this may be accomplished by supplying additional voice command files to the speech recognition engine for processing. The speech recognition engine may, in some cases, determine the accuracy of the speech recognition by calculating a percentage of accurate recognitions, and compare the accuracy of the speech recognition to a predetermined threshold. If the accuracy is at or above the threshold, the processing device may create an interpreted voice command that is stored in the interpreted voice command file with the appropriate corresponding commands. In contrast, if the accuracy is below the threshold, the recorded voice command file may be further processed by the server 103, or the server 103 may process additional recorded voice command files to improve the accuracy of the speech recognition until a desired accuracy level is reached. In further embodiments, the speech recognition process may similarly be “trained” to distinguish between different voices of different speakers.

As alluded to above, the speech recognition process may result in the creation of a speech recognition file that is transmitted by the server 103 to the first electronic device. In one embodiment, the speech recognition file may include an algorithm for converting voice commands to text, as well as a database including one or more voice commands and corresponding executed commands. The executable commands may correspond to various user-input controls of the second electronic device. For illustration purposes only, one example of a user-input control may be the “on” button of an electronic device, which may correspond to a sequence of executable commands for turning on the electronic device.

The server 103 may maintain one or more server databases 136 storing the recorded voice commands and the contents of the speech recognition file (including the algorithm and the database of voice commands and executable commands) for one or more users of the second electronic device. The server databases 136 may be stored on the server storage device 133. The entries in the databases 136 may be updated as more voice command recordings are received. For example, in one embodiment, the algorithm may be replaced with more accurate algorithms. Similarly, the executable commands corresponding to the algorithms may be changed. In other embodiments, the server 103 may allow for the inclusion of additional voice commands, as well as for the removal of voice commands from the databases 136.

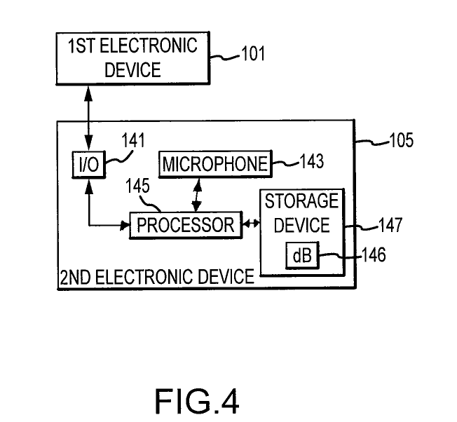

FIG. 4 illustrates one embodiment of a second electronic device 105 that may be used in conjunction with the embodiment illustrated in FIG. 1. As shown in FIG. 4, the second electronic device 105 may include a microphone 143, a storage device 147, a processing device 145, and an input/output port 141 for establishing a wired connection with the first electronic device 101. In other embodiments, the first and second electronic devices may be wirelessly connected, in which case the second electronic device 105 may further include a wireless transmitter and a receiver.

In one embodiment, the second electronic device 105 may be a digital music player. For example, the second electronic device 105 may be an MP3 player, such as an iPod, an iPod Nano™, or an iPod Shuffle™, as manufactured by Apple Inc. The digital music player may include a display screen and corresponding image-viewing or video-playing support, although some embodiments may not include a display screen. The second electronic device 105 may further include a set of controls with which the user can navigate through the music stored in the device and select songs for playing. The second electronic device 105 may also include other controls for Play/Pause, Next Song/Fast Forward, Previous Song/Fast Reverse, and up and down volume adjustment. The controls can take the form of buttons, a scroll wheel, a touch-screen control, a combination thereof, and so on and so forth.

As discussed above, various user-input controls of the second electronic device 105 may be accessed via a voice user interface. For example, the voice commands may correspond to virtual buttons or icons that may also be accessed via a touch-screen user interface, physical buttons, or other user-input controls. Some examples of applications that may be initiated via the voice commands may include applications for turning on and turning off the second electronic device. Additionally, where the second electronic device 105 takes the form of a digital music player, the user may speak the word “play” to play a particular song. As another example, the user may speak the words “next song” to select the next song in a playlist, or the user may state the title of a particular song to play the song.

It should be understood by those having ordinary skill in the art that the second electronic device 105 may be some other type of electronic device. For example, the second electronic device 105 may be a household appliance, a mobile telephone, a keyboard, a mouse, a compact disc player, a digital video disc, a computer, a television, and so on and so forth. Accordingly, it should also be understood by those having ordinary skill in the art that the voice commands may correspond to executable commands or macros different from those mentioned above. For example, the voice commands may be used to open and close the disc tray of a compact disc player or to change channels on a television. As another example, the voice commands may be used to open and display the contents of files stored on a computer. In further embodiments, the electronic device may not include any physical controls, and may respond only to voice commands. In such embodiments, all of the executable commands corresponding to the controls may be cross-referenced to appropriate voice commands.

As shown in FIG. 4, some embodiments of the second electronic device 105 may include a microphone 143 configured to receive voice commands from the user. The microphone may convert the voice commands into electrical signals, which may be stored on the data storage device 147 resident on the second electronic device 105 as a recorded voice command file. The second electronic device 105 may also be configured to transmit the recorded voice command file to the first electronic device, which, may, in turn, transmit the file to the server 103 for processing by the speech recognition engine.

The second electronic device 105 may further be configured to receive the speech recognition file (or the algorithm and a subset of the voice commands contained therein) from the first electronic device and store it as a database 146 in the storage device 147. As discussed above, the executable commands contained in the speech recognition file may correspond to various functions of the second electronic device. For example, where the second electronic device 105 is a digital music player, the executable commands may be the sequence of commands executed to play a song stored on the second electronic device. As another example, the executable commands may be the sequence of commands executed when turning on or turning off the device. The algorithm from the speech recognition file may be stored on the storage device 147 of the second electronic device 105. Additionally, one or more of the voice commands from the database of the speech recognition file, may be stored as a local database 146 on the storage device 147.

In another embodiment, the second electronic device 105 may transmit the recorded voice command file to the server 103 for processing by the speech recognition engine, rather than through the first electronic device 101. The server 103 may then transmit the speech recognition file back to the second electronic device 105.

The functions of the voice user interface may be performed by the processing device 145. In one embodiment, the processing device 145 may be configured to execute the algorithm contained in the speech recognition file to convert the recorded voice file into text. The processing device may then determine whether there is a match between the converted text and any of the voice commands stored in the database. If the processing device 145 determines that there is a match, the processing device 145 may access the local database 146 to execute the executable commands corresponding to the matching voice command.

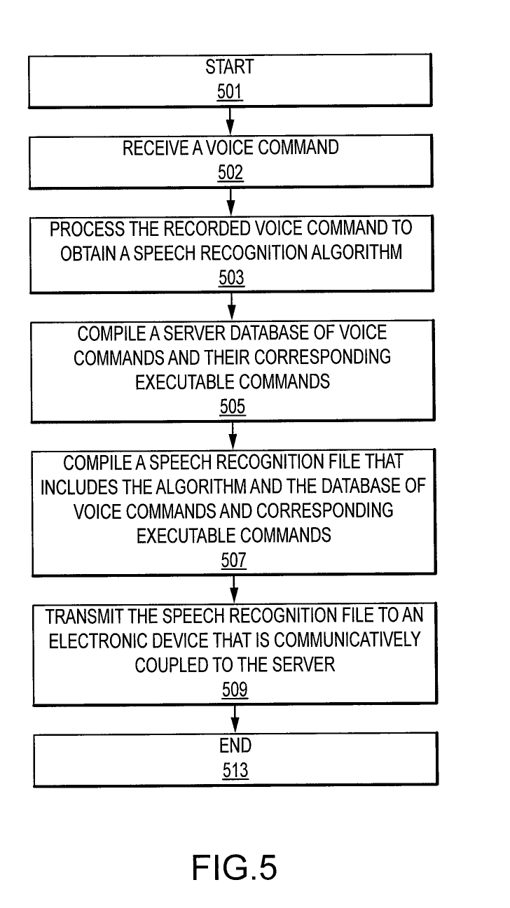

FIG. 5 illustrates a flowchart setting forth one embodiment of a method 500 for associating a voice command with an executable command. One or more operations of the method 500 may be executed on a server 103 similar to that illustrated and described in FIGS. 1 and 3. In the operation of block 501, the method may begin. In the operation of block 502, the server 103 may receive a voice command. As discussed above, the voice command may be a recorded voice command from an electronic device communicatively coupled to the server 103. In the operation of block 503, the server 103 may process the recorded voice command to obtain a speech recognition algorithm. In one embodiment the speech recognition algorithm may convert the recorded voice command into text.

In the operation of block 505, the server 103 may further compile a server database of voice commands and their corresponding executable commands. In one embodiment, the server 103 may receive the contents of the server database from the first electronic device 101 or the second electronic device 105. In another embodiment, the database may be created on the server 103. The executable commands may correspond to controls on the second electronic device. In the operation of block 507, the server 103 may compile a speech recognition file that includes the algorithm and the database of voice commands and corresponding executable commands. As discussed above, the speech recognition file may include one or more entries or tables associating the voice commands with the executable commands.

In the operation of block 509, the server 103 may transmit the file to an electronic device that is communicatively coupled to the server 103. In one embodiment, the electronic device may be configured to create a database that includes a subset of the voice commands contained in the speech recognition file. In the operation of block 513, the method is finished.

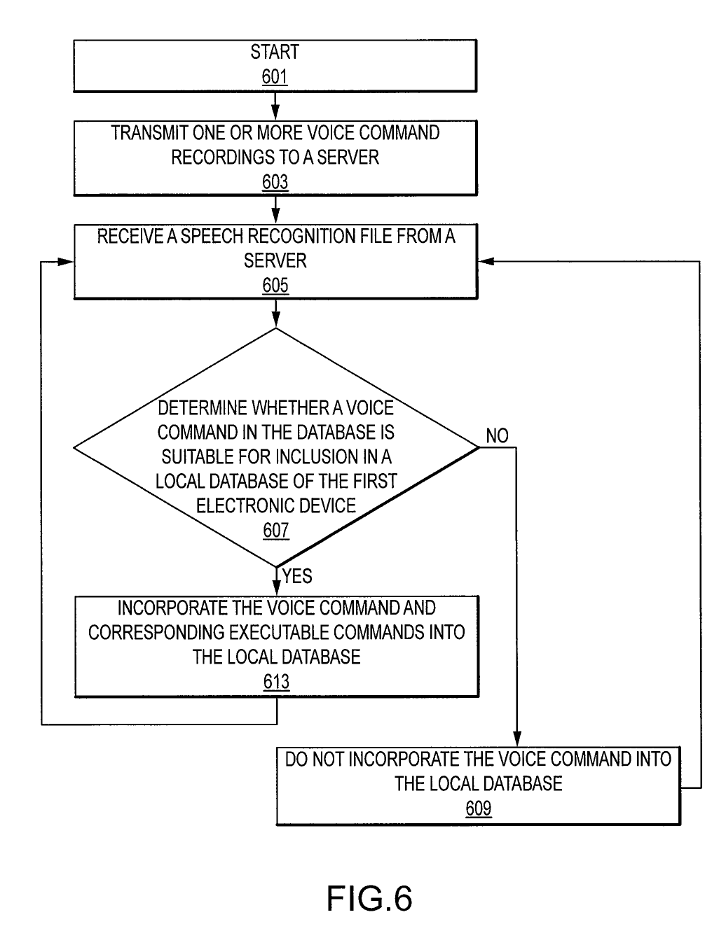

FIG. 6 illustrates a flowchart setting forth one embodiment of a method 600 for creating a database of voice commands. One or more operations of the method 600 may be executed on the first electronic device 101 shown and described in FIGS. 1 and 2, although in other embodiments, the method 600 can be executed on electronic devices other than the first electronic device. In the operation of block 601, the method may begin. In the operation of block 603, the first electronic device 101 may transmit one or more voice command recordings to a server 103. The voice command recordings may be recorded by the first electronic device 101 or may be recorded by the second electronic device 105 and transmitted to the first electronic device. In the operation of block 605, the first electronic device 101 may receive a speech recognition file from a server. The speech recognition file may contain a speech recognition algorithm, as well as a database including one or more voice commands and one or more executable commands corresponding to the voice commands. The one or more executable commands may correspond to controls on the second electronic device 105 or the first electronic device 101.

In the operation of block 607, the first electronic device 101 may determine whether a voice command in the database is suitable for inclusion in a local database of the first electronic device. If, in the operation of block 607, the first electronic device 101 determines that the received voice command is suitable for inclusion in the local database, then, in the operation of block 613, the first electronic device 101 may incorporate the voice command and corresponding executable commands into the local database. In some embodiments, this may be done selectively, in that the user may select the particular voice commands that are compiled in the local database. In other embodiments, the entire contents of the speech recognition file may be incorporated into the database.

If, in the operation of block 607, the first electronic device 101 determines that a voice command is not suitable for inclusion in the local database on the first electronic device, then, in the operation of block 609, the first electronic device 101 may not incorporate the voice command into the local database. The method may then proceed back to the operation of block 605, in which the first electronic device 101 may receive the next speech recognition file from the server 103.

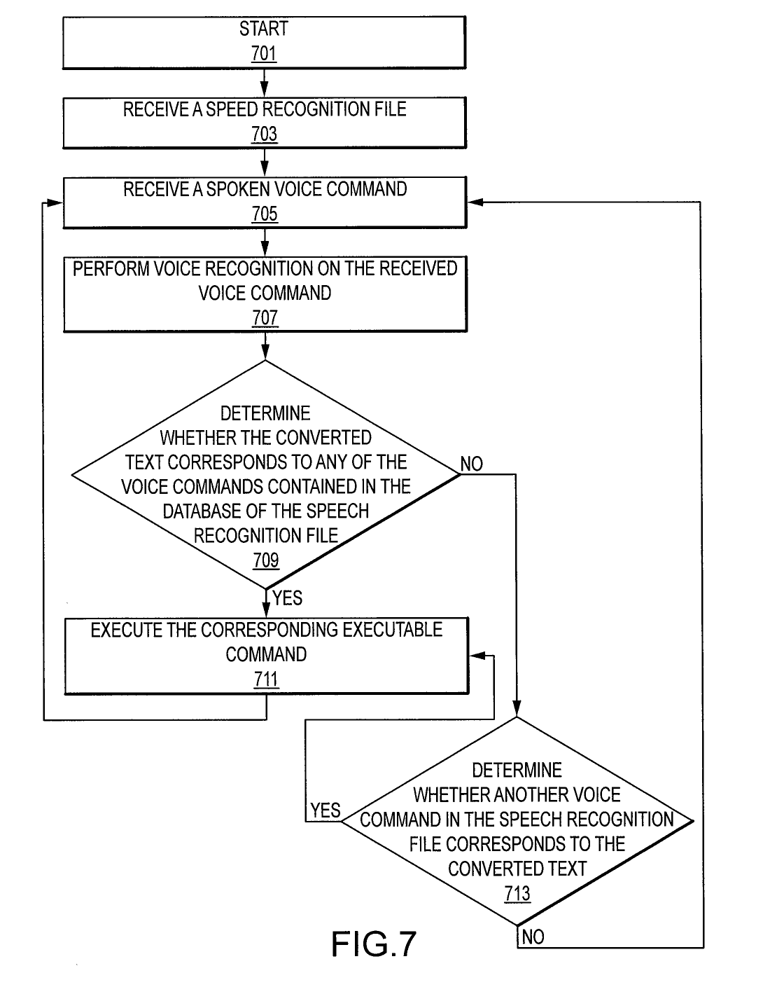

FIG. 7 illustrates a flowchart setting forth one embodiment of a method 700 for voice recognition. One or more operations of the method 700 may be executed on the second electronic device 105 shown and described in FIGS. 1 and 4, although in other embodiments, the method 600 can be executed on electronic devices other than the second electronic device. In the operation of block 701, the method may begin. In the operation of block 703, the second electronic device 105 may receive a speech recognition file. The speech recognition file may include a speech recognition algorithm, as well as a database including one or more voice commands in text form and corresponding executable commands. In one embodiment, the database may be compiled by the first electronic device 101 and transmitted to the second electronic device 105 when the devices are communicatively coupled to one another through a wired or wireless connection.

In the operation of block 705, the second electronic device 105 may receive a spoken voice command. For example, the second electronic device 105 may have a microphone configured to sense the user's voice. In the operation of block 707, the second electronic device 105 may perform voice recognition on the received voice command. In one embodiment, the speech recognition algorithm may be provided by the speech recognition file, which may be executed by the second electronic device 105 to convert the spoken voice command into text. In the operation of block 709, the second electronic device 105 may determine whether the converted text corresponds to any of the voice commands contained in the database of the speech recognition file. If, in the operation of block 709, the second electronic device 105 determines that the converted text corresponds to a voice command contained in the speech recognition file, then, in the operation of block 711, the corresponding executable command may be executed on the second electronic device. At this point, the method may return to the operation of block 705, in which the user may be prompted for another voice command.

If, however, the second electronic device 105 determines that converted text does not correspond to a voice command contained in the speech recognition file, then, in the operation of block 713, the second electronic device 105 may determine whether another voice command in the speech recognition file corresponds to the converted text. If, in the operation of block 713, the second electronic device 105 determines that another voice command in the speech recognition file corresponds to the converted text, then, in the operation of block 711, the corresponding executable command may be executed. If, however, the second electronic device 105 determines that none of the other voice commands in the speech recognition file corresponds to the converted text, then, in the operation of block 705, the user is prompted for another voice command.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element are all possible sequences of execution.

1. A voice control system, comprising:
a first electronic device arranged to be communicatively coupled to a server and configured to receive a speech recognition file from the server, the speech recognition file including a speech recognition algorithm for converting one or more voice commands into text and a database comprising one or more entries comprising one or more voice commands and one or more executable commands associated with the one or more voice commands.

2. The voice control system of claim 1, wherein the first electronic device is further configured to execute the algorithm to convert the one or more voice commands into text.

3. The voice control system of claim 2, wherein the text is compared to the one or more voice commands in the database to determine whether the text matches at least one of the one or more voice commands in the database.

4. The voice control system of claim 3, wherein, if the text matches at least one of the one or more voice commands in the database, the first electronic device is configured to execute at least one of the one or more executable commands associated with the at least one of the one or more voice commands in the database.

5. The voice control system of claim 1, wherein the first electronic device is further configured to transmit the algorithm and the database to a second electronic device communicatively coupled to the first electronic device.

6. The voice control system of claim 5, further comprising the second electronic device.

7. The voice control system of claim 5, wherein the second electronic device is further configured to execute the algorithm to convert the one or more voice commands into text.

8. The voice control system of claim 5, wherein the one or more executable commands correspond to controls on the second electronic device.

9. The voice control system of claim 8, wherein the second electronic device is communicatively coupled to the first electronic device by a wired connection.

10. The voice control system of claim 1, wherein the voice control system further comprises a server.

11. The voice control system of claim 10, wherein the first electronic device is communicatively coupled to the server through a wireless network.

12. A method for creating a database of voice commands on a first electronic device, comprising:
transmitting a voice recording file to a server;
receiving a first speech recognition file from the server, the first speech recognition file including a first speech recognition algorithm and a first database comprising one or more entries comprising one or more voice commands and one or more executable commands corresponding to the one or more voice commands; and
creating a second database comprising one or more entries from at least one of the one or more entries of the first database of the speech recognition file.

13. The method of claim 12, further comprising:
receiving a second speech recognition file from a server, the second speech recognition file including a second speech recognition algorithm and a third database comprising one or more entries comprising one or more voice commands and one or more executable commands corresponding to the one or more voice commands; and
adding at least one or the one or more entries of the third database to the second database.

14. The method of claim 12, wherein the one or more voice commands of the first speech recognition correspond to a second electronic device communicatively coupled to the first electronic device.

15. The method of claim 12, further comprising:
receiving a voice command;
executing the speech recognition algorithm to convert the voice command to text.

16. A voice control system comprising:
a server configured to receive a voice command recording, the server configured to process the voice command recording to obtain a speech recognition file comprising a speech recognition algorithm and a database comprising one or more voice commands and one or more executable commands corresponding to the one or more voice commands;
wherein the server is further configured to transmit the speech recognition algorithm to a first electronic device communicatively coupled to the server.

17. The voice control system of claim 16, wherein the database comprises a look-up table.

18. The voice control system of claim 16, further comprising the first electronic device, wherein the first electronic device is configured to record a voice command to obtain the voice command recording.

19. The voice control system of claim 18, further comprising a second electronic device, the second electronic device configured to record a voice command to obtain the voice command recording.

20. The voice control system of claim 19, wherein the one or more executable commands correspond to controls on the second electronic device.
